(19) United States
(12) Patent Application Publication
(10) Pub. No.: US 2009/0125311 A1
(43) Pub. Date: May 14, 2009

(54) VEHICULAR VOICE CONTROL SYSTEM

(76) Inventors: Tim Haulick, Blaubeuren (DE); Markus Buck, Biberach (DE); Marcus Hennecke, Graz (AT)

Correspondence Address: HARMAN - BRINKS HOFER CHICAGO;Brinks Hofer Gilson & Lione, P.O. Box 10395, Chicago, IL, 60610, US

(21) Appl. No.: 11/865,930

(22) Filed: Oct. 2, 2007

(30) Foreign Application Priority Data
Oct. 2, 2007 (EP) 06020730.5

(51) Int. Cl. G10L 11/00

(52) U.S. Cl. 704/275

(57) ABSTRACT

A vehicular voice control system includes a first and a second microphone located on a vehicle external to a vehicle cabin. The microphones receive audio signals from an audio source external to the vehicle and generate microphone output signals. A signal processor processes the microphone output signals, generates a processed signal, and determines a location of the audio source. A speech recognition system receives the processed signal and obtains a recognition result. A controller controls one or more vehicular elements based on the recognition result and the determined location of the audio source.

### PRIORITY CLAIM

This application claims the benefit of priority from European Patent Application No. 06 020730.5, filed Oct. 2, 2006, which is incorporated by reference.

### BACKGROUND OF THE INVENTION

1. Technical Field

This disclosure relates to control of vehicular functions. In particular, this disclosure relates to voice control of vehicular functions.

2. Related Art

Occupants of vehicles may operate different equipment in a vehicle cabin. Some equipment, such as side-view mirrors, may be manipulated by hand or by servo motors. Other equipment, such as locks or latches, are usually operated manually, either by use of a key or applying pressure to a lever or button. To release the hood or trunk, a user outside of the vehicle typically inserts a key into a locking mechanism. However, this may be difficult or inconvenient if the user's hands are not free.

### SUMMARY

A vehicular voice control system includes a first and a second microphone located on the vehicle external to a vehicle cabin. The microphones receive audio signals from an audio source external to the vehicle and generate microphone output signals. A signal processor processes the microphone output signals, generates a processed signal, and determines a location of the audio source. A speech recognition system receives the processed signal and obtains a recognition result. A controller controls one or more vehicular elements based on the recognition result and the determined location of the audio source.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a rear view of a vehicle.

FIG. 2 is a perspective view of a vehicle.

FIG. 3 is a vehicle control system.

FIG. 4 is a lens housing having three vertically arranged microphones.

FIG. 5 is a lens housing having three horizontally arranged microphones.

FIG. 6 is a lens housing having three diagonally arranged microphones.

FIG. 7 is a lens housing having three microphones arranged in a substantially L-shape.

FIG. 8 is a lens housing having four microphones arranged in a square.

FIG. 9 is a lens housing supporting circularly arranged microphones.

FIG. 10 is a lens housing supporting elliptically arranged microphones.

FIG. 11 is a beamforming circuit.

FIG. 12 shows ambient noise signals and speech signals.

FIG. 13 is a vehicle voice control process.

### DETAILED DESCRIPTION OF THE PREFERRED EMBODIMENTS

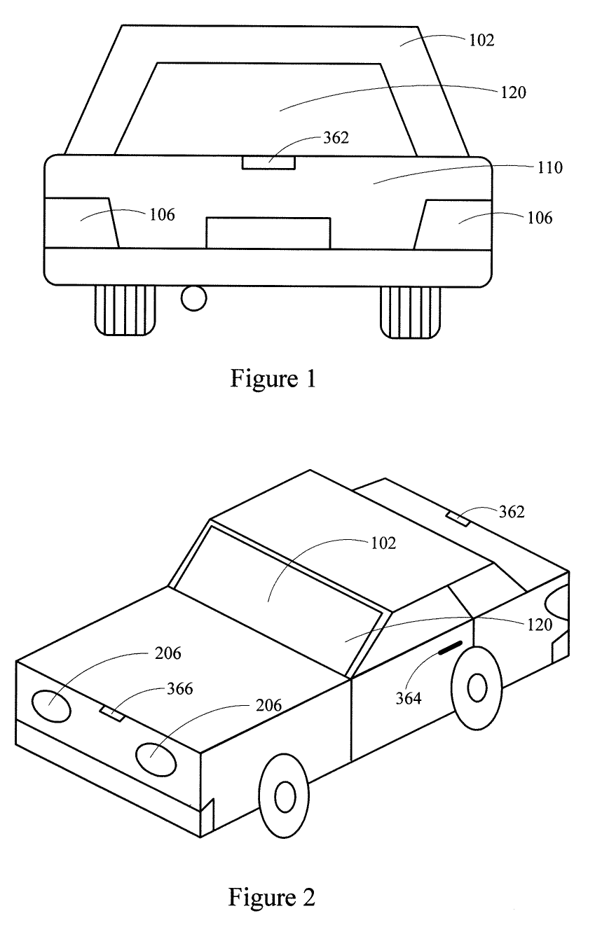

FIG. 1 is a rear view of a vehicle 102, such as an automobile. The vehicle 102 may include two or more lamp housings 106, such as tail lens housings. The vehicle 102 may include a hatch or trunk lid 110 and a latch, along with an actuator configured to release the latch when activated. The vehicle 102 may include a vehicle cabin 120. FIG. 2 is a perspective view of the vehicle 102, which may include two or more headlight housings 206. The vehicle 102 may include tail lamp housing, and may also include a roof-mounted housing for supporting microphones or audio transducers.

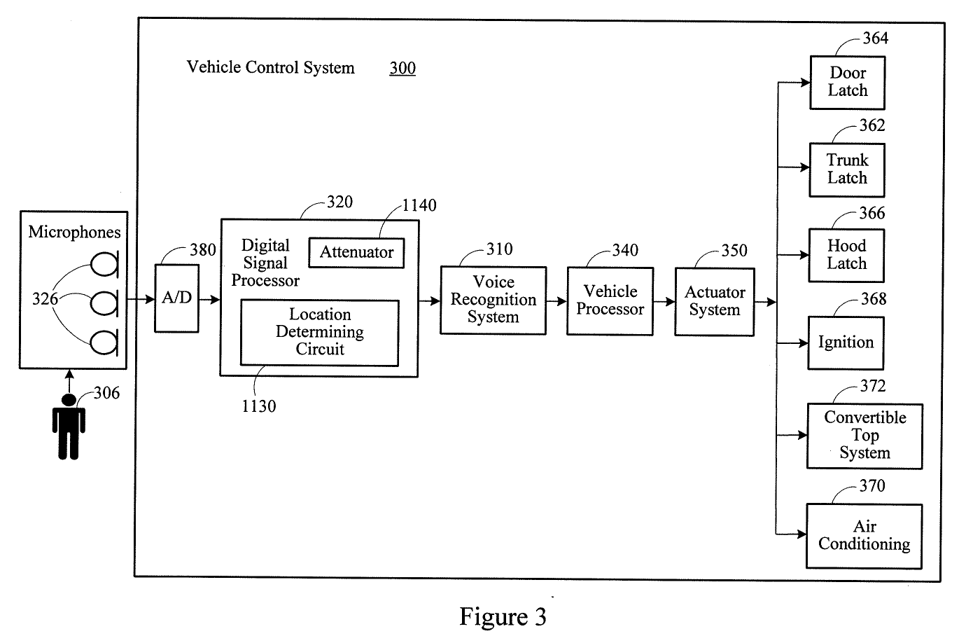

FIG. 3 is a vehicle control system 300 that controls vehicle functions using voice commands. A user 306 may approach the back of the vehicle 102 and may wish to open the vehicle trunk or hatch 110 without a manual engagement. The user 306 may give a verbal command to cause the vehicle trunk or hatch 110 to open. This may be convenient if the user's hands are not free, for example, if the user 306 is carrying one or more objects. Other functions may be activated by the user 306 through verbal commands while outside of the vehicle 102.

To respond to verbal commands issued by the user 306, the vehicle control system 300 may include a voice recognition system 310 in communication with a digital signal processor 320. One or more devices that convert sound into operating signals, such as sound transducers, may be mounted external to the vehicle cabin 120. The devices or microphone 326 may receive audio signals from a speaker or user 306 located outside of the vehicle 102. The voice recognition system 310 may process the signals from the microphones 326 through the digital signal processor 320. A vehicle computer or processor 340 may receive input from the voice recognition system 310, which may generate a recognition result. Based on the recognition result, the vehicle computer 340 may provide commands to an actuator system 350. The actuator system 350 may activate a vehicle function, such as releasing trunk latch 362, a door latch 364, a hood latch 366 and/or may activate a vehicle ignition system 368. The user 306 may also issue a command while outside of the vehicle 102 to turn on an air-conditioning system 370 to cool the vehicle, or control the operation of a convertible top system 372.

The voice recognition system 310 may recognize limited vocabularies, may process various speech patterns as well as accents, and may “learn” by receiving weighted inputs that, with adjustment time, and repetition, can produce a desired result. The digital signal processor 320 may process the digitized speech signal in parallel with the voice recognition system 310. The digital signal processor 320 or the voice recognition system 310 may perform spectral analysis. An analog-to-digital converter 380 may convert the output of the microphones 326 to digital form. The digitized speech may be sampled at a rate about between 6.6 kHz and 22.1 kHz. Representations of the digitized speech may be derived from the short term power spectra, and may represent a sequence of characterizing vectors containing values referred to as features or feature parameters. The values of the feature parameters may be used in succeeding processing stages to generate a probability estimate that the portion of the analyzed waveform corresponds to a word in a vocabulary list. The voice recognition system 310 may recognize verbal utterances as either isolated words or continuous speech captured by the microphones 326.

The recognition result provided by the voice recognition system 310, for example, an entry in a vocabulary list, may represent the verbal utterance or command issued by the user 306. For example, if the user 306 issues a command “open hatch,” an appropriate recognition result may provide access to the compartment. Based on a recognition result, the vehicle computer 340 may direct the actuator system 350 to open the trunk latch 362 via mechanical linkage, or electronic control of the physical hatch latch. Manual operation by the user 306 may be obviated.

The voice recognition system 310 may process the digitized audio signals and issue a command to the actuator system 350 corresponding to the command spoken by the user 306. Based on the issued command, the actuator system 350 may activate or release the trunk latch 362, the door latch 364, or the hood latch 366, or may activate the vehicle ignition system 368 or the convertible top 372.

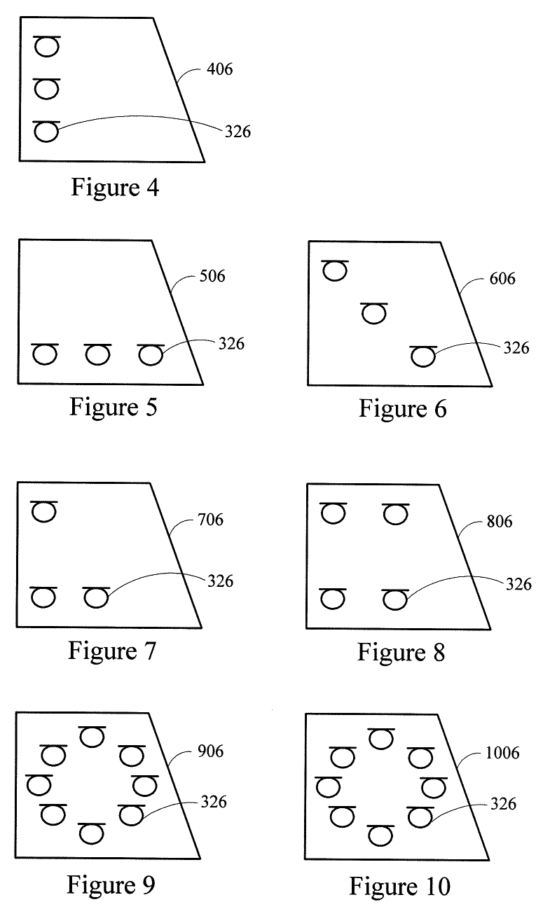

FIG. 4 is a lens housing 406 having three microphones 326 arranged in a substantially vertical pattern toward an outside portion of the lens housing. The vertical pattern of the microphones 326 may be placed at an inside portion or middle portion of the lens housing. The microphones 326 may be installed in one or both of the tail light housings 406. Providing electrical connections to the microphone may source the power to the microphone. Installation may be simplified because drilling holes in the vehicle body or lens housing 406 may be avoided. Placement of the microphones 326 in the lens housing 406 may minimize undesirable detection of structure-borne noise or impact sound caused by rain and other precipitation.

The microphones 326 may be installed in a lens housing that is fixed to the vehicle body rather than in a lens housing fixed to the hatch 110 or trunk of the vehicle 102. Lens housings that are fixed to the hatch or trunk 110 may move when the hatch or trunk is opened, which may adversely affect the audio signal received by the microphones 326 due to their changing position.

FIG. 5 is a lens housing 506 having multiple microphones 326 arranged in a substantially horizontal pattern toward a bottom portion of the lens housing. The horizontal pattern of microphones 326 may be placed toward the top portion or middle portion of the lens housing 506. The microphones 326 may sense direction (e.g. sound localization) or may be sensitive to a sound pattern.

FIG. 6 is a lens housing 606 having multiple microphones 326 arranged in a diagonal pattern sloping from the top left toward the bottom right of the lens housing. The diagonal pattern of microphones 326 may also slope from the top right toward the bottom left of the lens housing 606.

FIG. 7 is a lens housing 706 having multiple microphones 326 arranged in an L-shaped pattern. The L-shaped pattern may be rotated in ninety degree increments, or may be rotated by any predetermined number of degrees. This configuration may minimize auditory masking.

FIG. 8 is a lens housing 806 having multiple microphones 326 arranged in a square pattern. The four microphones 326 may also be arranged in a rectangular pattern and may sense sound in one position that may be masked by noise at another position.

FIG. 9 is a lens housing 906 having a plurality of microphones 326 arranged in a substantially circular pattern, while FIG. 10 is a lens housing 1006 having a plurality of microphones 326 arranged in an elliptical pattern. A polygonal microphone pattern may be used.

The pattern of microphones 326 may be located in any housing of the vehicle 102, such as the left or right tail light housing 102, the left or right headlight housing 206, a fog light housing, and a turn signal housing. The microphones may be housed on other housings on or in the vehicle. For example, a plurality of microphones may be supported on or in a structure located on the roof, hood, trunk or other vehicle structure. Such lens or housing structures may be made of plastic or glass, which may conduct sound well. Audio signals, such as verbal commands, may be received by the microphones 326 without significant attenuation through the material from which the lens or housing is formed.

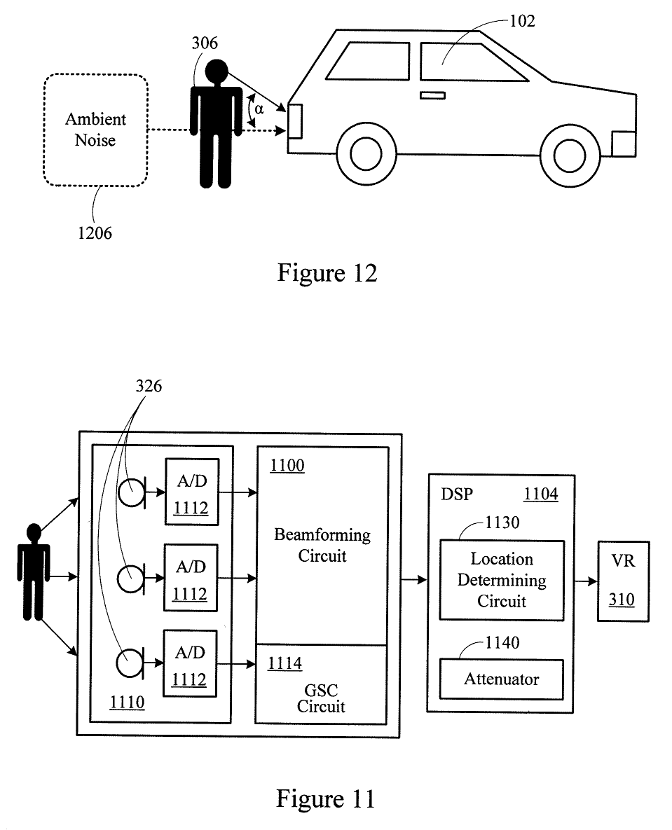

FIG. 11 is a beamforming circuit 1100 in communication with the plurality of microphones 326, including a digital signal processor 1104. The digital signal processor 1104 may be separate from the beamforming circuit 1100. The microphones 326 shown in FIGS. 4-10 may each comprise a microphone array 1110. The microphones 326 shown in the figures may comprise one or more microphone arrays 1110. Analog-to-digital converters 1112 may convert the output of the microphones 326 into digital data. The arrangement or pattern of the microphones 326 may affect beamforming of the individual microphone signals. The beamforming circuit 1100 may be used when two or more microphones 326 are arranged vertically or are offset vertically relative to each other. In beamforming, a vertical angle of incidence of acoustic signals may be determined from a difference in receipt times of microphone signals.

The beamforming circuit 1100 may be a fixed beamformer, such as a delay-and-sum beamformer. The beamforming circuit 1100 may be an adaptive beamformer having permanent adaptive filter coefficients. The beamforming circuit 1100 may include the processes described in “Adaptive Beamforming for Audio Signal Acquisition,” by Herbordt and Kellermann, from a book entitled “Adaptive Signal Processing: Applications to Real-World Problems,” p. 155, Springer, Berlin 2003. The beamforming circuit 1100 may include a general sidelobe canceling (GSC) circuit 1114. The GSC circuit may include processes described in “An Alternative Approach to Linearly Constrained Adaptive Beamforming,” by Griffiths and Jim, IEEE Transactions on Antennas and Propagation, vol. 30, p. 27, 1982. The GSC circuit may include a first adaptive path having a blocking matrix and an adaptive noise canceling circuit, and a second non-adaptive path having a fixed beamforming circuit.

FIG. 12 illustrates audio signals detected by a plurality of microphones 326 or a microphone array 1110 from two audio sources. A user 306 may approach the vehicle 102 from the back and utter commands to the vehicle control system 300. The microphone array 1110 may receive the audio signals from the user 306, which audio signals may be incident upon the microphone array 1110 at a particular angle above a substantially horizontal plane, depending upon the height of the user 306 and distance from the vehicle 102. The microphone array 1110 may also detect ambient noise 1206. Ambient noise 1206 may be incident upon the microphone array 1110 at a low angle, for example, about zero degrees, relative to the horizontal plane. The ambient noise 1206 may originate from a distant source relative to the speaker's position.

The digital signal processor 1104 may determine a difference in the receipt times between the signals of the individual microphones 326 or the microphones in the microphone array 1110. This may be based on the time that each microphone 326 receives the audio signal from a particular source. An uppermost microphone of a vertical microphone arrangement may detect the speech signal before a lowermost microphone detects the same speech signal. Minimal time difference may be detected for the ambient noise 1206 because the incident angle is about zero degrees relative to the individual microphones 326. The audio signal corresponding to noise may reach each of the microphones 326 essentially at the same time.

A verbal utterance by the user 306 may originate at a finite vertical angle α with respect to the horizontal plane. Thus, the user's a speech signal may be detected by the substantially vertically arranged microphones 326 at slightly different times. Based on the measured time difference, the digital signal processor 1104 or a location determining circuit 1130 within the digital signal processor 1104 may determine a vertical angle of incidence α of the speech signal. The vertical angle of incidence may establish the location of the source of the audio signal, namely the speaker, relative to the microphones 326. A location determining circuit 1130 may be separate from the digital signal processor 1104.

Based on the measured vertical angle α, an attenuation circuit 1140 may attenuate audio signals having a vertical angle αelow, for example, between about 10 to 20 degrees. The attenuation circuit 1140 may be part of the beamforming circuit 1100 or the digital signal processor 1104, or may be a separate circuit. Thus, the ambient noise 1206 signals may be attenuated while preserving the speech signals. Such multi-channel signal processing by the digital signal processor 1104 or beamforming circuit 1100 may enhance the signal-to-noise ratio of the speech signal. This may increase voice recognition accuracy. Beamforming may include amplifying microphone signals corresponding to audio signals detected from a desired direction by equal phase addition. Beamforming may also include attenuation of microphone signals corresponding to audio signals originating from undesired directions.

The plurality of microphones 326 or the individual microphones of a particular microphone array 1110 need not necessarily be located in a single lens housing. For example, one or more microphones 326 of a vertically arranged array may be installed in the left side tail lens, while other microphones 326 of the vertically arranged array may be installed in the right side tail lens. Because the microphone arrays 1110 may be separated by a relatively large distance, a high spatial resolution of the direction of the speech signal may be available. However, it may be more cost-effective to have a microphone array 1110 installed in a single lens housing.

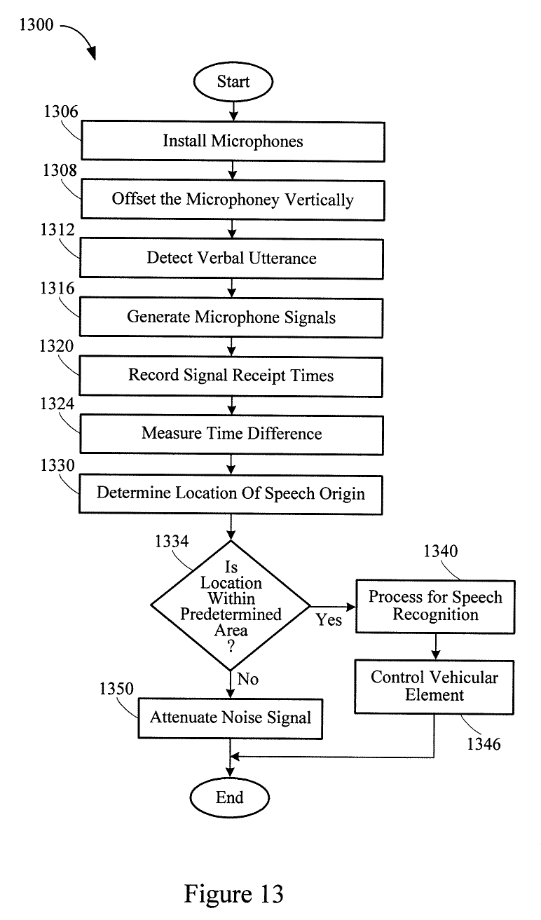

FIG. 13 is a vehicle control process 1300. A first and a second sound transducer may be positioned on the vehicle (Act 1306) external to the vehicle cabin. The first sound transducer may be vertically offset from the second sound transducer (Act 1308). The first sound transducer and the second sound transducer may then detect a verbal command (Act 1312), and may generate corresponding sound transducer output signals (Act 1316). Next, the times that the first and second sound transducers receive the verbal utterance or command may be recorded to generate first and second receipt times, respectively (Act 1320). A processor may measure the difference between the first and second receipt times (Act 1324). The processor may then determine a location of the source of the verbal utterance or command based on the measured time difference (Act 1330). If the determined location is within a predetermined area (Act 1334) relative to the sound transducers, the sound transducer output signals may be processed for speech recognition of the verbal command to obtain a result (Act 1340), and a vehicle element may be controlled (Act 1346). If the determined location of the verbal command is received outside of the predetermined area, the corresponding sound transducer output signal may be attenuated (Act 1350). In some circumstances the signal is reduced because it may correspond to a noise signal.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for voice control of at least one vehicular element, comprising:
arranging at least one microphone on a vehicle external to a vehicle cabin;
detecting a verbal utterance of a speaker by the microphone and generating a microphone output signal;
processing the microphone output signal to determine a location of the speaker;
processing the microphone output signal for speech recognition of the verbal utterance to obtain a recognition result; and
controlling the vehicular element based on the recognition result and the location of the speaker.

2. The method of claim 1, where the at least one vehicular element is a hood latch, a hatch latch, a trunk latch, a convertible top actuator, a door latch, or an ignition switch.

3. The method of claim 1, where the at least one microphone is installed in the housing of a rear light, a headlight, a turn signal light, or a fog lamp.

4. The method of claim 3, where at least two microphones are arranged in vertical, horizontal, or diagonal pattern in the housing.

5. The method claim 3, where at least three microphones are arranged in a triangular pattern or L-shaped pattern in the housing.

6. The method according to claim 3, where at least four microphones are arranged in the housing in a polygonal pattern, a square pattern, a rectangular pattern, a circular pattern, or an elliptical pattern.

7. The method of claim 1, comprising:
providing a microphone array in the lamp housing, the microphone array generating a microphone array output signal;
beamforming the microphone array output signal to generate a beamformed signal; and
processing the beamformed signal to obtain the recognition result.

8. The method of claim 1, comprising:
providing a first and a second microphone on the vehicle external to the vehicle cabin;
measuring a time that the first microphone receives audio signals corresponding to an audio source, to generate a first receipt time;
measuring a time that the second microphone receives the audio signals corresponding to the audio source, to generate a second receipt time;
measuring the difference between the first and second receipt times;
determining a location of the audio source based on the measured time difference;
determining that the audio signals correspond to the verbal utterance of the speaker if the location of the audio source is within a predetermined area relative to the microphones;
determining that the audio signals correspond to noise signals if the location of the audio source is not within the predetermined area, and
attenuating an output of microphones receiving the noise signals.

9. The method of claim 8, where the first microphone is offset vertically from the second microphone.

10. The method of claim 8, where the first and second microphones are arranged in a diagonal pattern.

11. The method of claim 8, comprising a third microphone arranged in an L-shaped pattern with the first and second microphones.

12. The method of claim 8, comprising a second microphone and a third microphone arranged in a square or rectangular pattern with the first and second microphones.

13. The method of claim 8, where the determined location of the audio source corresponds to a vertical angle of the audio source relative to the microphones.

14. A method for voice control of at least one vehicular element, comprising:
arranging a first and a second microphone on the vehicle external to the vehicle cabin, the first microphone vertically offset from the second microphone;
detecting a verbal utterance of a speaker by the first microphone and the second microphone, and generating microphone output signals;
measuring a time that the first and second microphones receive the verbal utterance, to generate first and second receipt times, respectively;
measuring the difference between the first and second receipt times;
determining a location of the source of the verbal utterance based on the measured time difference; and
if the determined location is within a predetermined area relative to the microphones, then processing the microphone output signals for speech recognition of the verbal utterance to obtain a recognition result and controlling the vehicular element based on the recognition result.

15. A method for voice control of at least one vehicular element, comprising:
arranging a first and a second microphone on the vehicle external to the vehicle cabin, the first microphone vertically offset from the second microphone;
detecting a verbal utterance of a speaker by the first microphone and the second microphone, and generating microphone output signals;
measuring a time that the first and second microphones receive the verbal utterance, to generate first and second receipt times, respectively;
measuring the difference between the first and second receipt times;
determining a location of the source of the verbal utterance based on the measured time difference;
if the determined location is within a predetermined area relative to the microphones, then processing the microphone output signals for speech recognition of the verbal utterance to obtain a recognition result and controlling the vehicular element based on the recognition result; and
if the determined location is outside of the predetermined area relative to the microphones, then attenuating the corresponding microphone output signal.

16. A vehicular voice control system, comprising:
a first and a second microphone located on a vehicle external to a vehicle cabin, configured to receive audio signals from an audio source external to the vehicle and generate microphone output signals;
a signal processor configured to process the microphone output signals to generate a processed signal and determine a location of the audio source;
a speech recognition system configured to receive the processed signal and to obtain a recognition result; and
a controller configured to control one or more vehicular elements based on the recognition result and the determined location of the audio source.

17. The system of claim 16, where the vehicular element is a hood latch, a hatch latch, a trunk latch, a convertible top actuator, a door latch, or an ignition switch.

18. The system of claim 16, where first and second microphones are located in a housing of a rear light, a headlight, a turn signal light, or a fog lamp.

19. The system of claim 16, where the first microphone is vertically offset from the second microphone.

20. The system claim 16, comprising a third microphone arranged in a triangular pattern or L-shaped pattern with the first and second microphones.

21. The system according to claim 16, comprising third and fourth microphones arranged with the first and second microphones in a polygonal pattern, a square pattern, a rectangular pattern, a circular pattern, or an elliptical pattern.

22. The system of claim 16, comprising a beamforming circuit in communication with the microphones and the signal processor configured to generate a beamformed signal.

23. The system of claim 19, comprising:
a first signal receipt time measured by the signal processor corresponding to a time that the first microphone receives the audio signals;
a second signal receipt time measured by the signal processor corresponding to a time that the second microphone receives the audio signals;
a location determining circuit configured to determine a location of the audio source based on the first and second receipt times;
the signal processor determining that the audio signals correspond to a verbal utterance if the determined location of the audio source is within a predetermined area relative to the microphones; and
an attenuation circuit configured to attenuate an output of corresponding microphones receiving audio signals from a location outside of the predetermined area.

24. A vehicular voice control system, comprising:
first and second microphones located on a vehicle external to a vehicle cabin, configured to receive audio signals from an audio source external to the vehicle and generate microphone output signals;
a signal processor configured to process the microphone output signals to generate a processed signal and determine a location of the audio source;
a location determining circuit configured to determine a location of the audio source based on a time that the first and second microphones receive the audio signals, respectively;
a speech recognition system configured to receive the processed signal and to obtain a recognition result;
a controller configured to control one or more vehicular elements based on the recognition result and the determined location of the audio source.

25. The system of claim 24, where the first microphone is vertically offset from the second microphone.
